(19) United States
(12) Patent Application Publication
(10) Pub. No.: US 2017/0009892 A1
(43) Pub. Date: Jan. 12, 2017

(54) VALVE PLUNGER

(71) Applicant: VAT HOLDING AG, Haag (CH)

(72) Inventors: Florian Ehrne, Frumsen (CH); Christof Bachmann, Sennwald (CH); Martin Netzer, Bludenz (AT); Matthias Wozasek, Fussach (AT)

(73) Assignee: VAT Holding AG, Haag (CH)

(21) Appl. No.: 15/121,203

(22) PCT Filed: Feb. 27, 2015
(86) PCT No.: PCT/EP2015/000467

§ 371 Date: Aug. 24, 2016

(30) Foreign Application Priority Data
Mar. 18, 2014 (AT) A 199/2014

(51) Int. Cl. F16K 3/02; F16K 51/02

(52) U.S. Cl. CPC F16K 3/0263; F16K 3/0218; F16K 3/0254; F16K 51/02

(57) ABSTRACT

A valve rod (12) for a vacuum valve, the plunger having a first connection region (40) for a closure member (5) of the vacuum valve and at least one second connection region (41) for a valve drive of the vacuum valve. At least some sections of the valve rod (12) have a material (42) with an elastic modulus of at least 250 gigapascal, preferably at least 350 gigapascal.

### BACKGROUND

The present invention relates to a valve rod for a vacuum valve, comprising a first connection region for a closure member of the vacuum valve, and comprising at least one second connection region for a valve drive of the vacuum valve. Furthermore, the invention also relates to a vacuum valve.

Valve rods of this type are known, for example, from DE 10 2008 049 353 A1. The closure member is fastened to one end of such valve rods. At the other end, the valve rods are connected to a valve drive, of whatever type, which serves to adjust the closure member, generally to and fro, between at least one open position and at least one closed position. The valve rods therefore serve to connect the closure member to the valve drive. Generally in the case of vacuum valves, the closure member is located in a vacuum region, while the valve drive is often arranged in a different region which is generally under normal pressure. In order to seal off these two regions from each other, bellows or other feedthroughs to the valve rod are frequently used in the prior art.

In the course of the further development of the vacuum valves, there is the fundamental necessity of managing with continually reduced construction space.

### SUMMARY

It is an object of the invention to improve a valve rod for a vacuum valve to the effect that it takes up as little construction space as possible.

To achieve this objective, the invention provides that at least sections of the valve rod comprise a material having a modulus of elasticity of at least 250 gigapascal, preferably of at least 350 gigapascal.

Provision is therefore made, for the formation of the valve rod, to take into consideration materials having a rigidity and hardness of a magnitude not hitherto taken into consideration in the vacuum valve sector. It should be borne in mind in this connection that vacuum technology is used as clean room technology for manufacturing highly sensitive and especially electronic and optical components. In these working areas, it is often crucial to avoid even the smallest contamination of the process chambers and the process atmosphere. For these reasons, valve rods comprised of high grade steels and the like have hitherto always been used for vacuum valves. The newly proposed materials having a modulus of elasticity of at least 250 gigapascal, preferably of at least 350 gigapascal, are substantially harder and also more brittle than the materials hitherto used for valve rods. It is surprising to a person skilled in the art that corresponding materials can be used under clean room conditions, as are required for valve rods for a vacuum valve. By the use of these very stiff materials, it is possible at any rate to form the valve rod to be substantially more slender than hitherto, and therefore construction space for the formation of the vacuum valve can be saved overall without the compressive strength being reduced when the valve opening is closed by use of the closure member.

The material having the modulus of elasticity of at least 250 gigapascal, preferably of at least 350 gigapascal, is preferably a ceramic or a hard metal. Aluminum oxide (Al2O3), silicon carbide (SiC), silicon nitride (Si3N4) and zirconium oxide (ZrO2) can be mentioned as an example of technically suitable ceramics. Said ceramics can be processed by means of sintering, reaction binding, hot pressing and/or hot isostatic pressing and shaped into correspondingly required solid state bodies. The moduli of elasticity of correspondingly suitable ceramics often lie within the range of 250 gigapascal to 500 gigapascal. These are preferably what are referred to as high performance ceramics which are defined in DIN V ENV 12212 as an advanced ceramic material which has a high performance capability, is predominantly non-metallic and inorganic and has certain expedient properties. In this connection, it should be pointed out that suitable ceramics within this context may also comprise metallic portions, in particular carbides.

As an alternative to the ceramic, hard metal, for example, may also be used. Such hard metals preferably comprise carbides. Particularly preferably, suitable hard metals have a carbide portion of at least 50% by vol. As a further constituent, said hard metals may comprise binders containing softer metal, for example iron-based materials, in particular steel. The hard metals are produced with the metallic binder by powder metallurgy. The typical modulus of elasticity is above 400 gigapascal. Particularly preferred hard metals comprise tungsten carbide (WC) and/or titanium carbide (TiC) and/or tantalum carbide (TaC) and/or niobium carbide (NbC), preferably with a volumetric portion of more than 50%. The hard metals are characterized by their great hardness and their metallic properties.

The material having a modulus of elasticity of at least 250 gigapascal, preferably of at least 350 gigapascal, is preferably in the form of a continuous, elongate solid state body. Particularly preferably, this material is in the form of a tube or a rod. A tube here is an elongate solid state body having a cavity which runs in its interior over the longitudinal extent and is generally open toward the end sides. The casing wall of the tube otherwise advantageously surrounds said cavity with a closed circumference. A rod is a continuous, elongate solid state body without an internal cavity. The rod is therefore generally of continuously solid design. However, in conjunction with the term “valve rod”, it is pointed out that the customary term is referred to here. Alternatively, a closure member carrier could also be discussed for the valve rod. It should be pointed out that the valve rod could in general be shaped very differently and, for example, also designed as a tube. However, for the sake of simplicity, use is made here of the customary definition of the valve rod, which is intended to include all of this. At any rate, the valve rod is advantageously a preferably rectilinear, elongate solid state body, the length of which is generally significantly larger than its diameter. The valve drive can be designed in very different ways, as known per se in the prior art. It is preferably a valve drive which moves the closure member between its maximally open position and its closed position, in which the closure member is pressed against the valve seat, in at least two directions which are not parallel to each other, but rather are angled, in particular are orthogonal, with respect to each other. Such valve drives are also known under the term “L drive”. Of course, however, other valve drives known per se in the prior art may also be combined with a valve rod according to the invention.

The closure member is preferably a valve disk, i.e. a type of plate-like closure member. The width or longitudinal extent of the valve disk is preferably significantly greater than the diameter of the valve rod. Alternatively, however, the closure member could also be, for example, a closure needle or the like, for example if it is used in a metering valve.

For the sake of completeness, it is pointed out that the material having a modulus of elasticity of at least 250 gigapascal, preferably at least 350 gigapascal, may be both a mono-mineral and a material composition or material mixture. However, for the sake of simplicity, a material is always referred to, even if it may be a material mixture.

Valve rods according to the invention can be of multi-part design. This means that they do not have to be comprised only of the material having the modulus of elasticity of at least 250 gigapascal, preferably of at least 350 gigapascal. Nevertheless, it should be pointed out that it is surprisingly possible, even in the vacuum region, to use valve rods, sections of which may be comprised exclusively of the material mentioned. As an alternative thereto, in particular within the context of the avoidance as absolutely as possible of contaminations of the process chambers or process gases or outgassing into the process chambers or process gases, it can be provided to clad the material having a modulus of elasticity of at least 250 gigapascal, preferably of at least 350 gigapascal. This cladding is preferably formed at least in the region in which the valve rod can be located in the vacuum region. In a first embodiment of a cladding, it can be provided that the continuous, elongate solid state body is arranged in an oblong internal cavity of an outer tube of the valve rod, wherein the outer tube of the valve rod is composed of a different material than the continuous, elongate solid state body. Here, the material forming the continuous, elongate solid state body and having a correspondingly high modulus of elasticity is therefore arranged as a type of core in an internal cavity of the outer tube. Advantageously, the gases surrounding the valve rod are therefore connected exclusively to the outer tube. The outer tube can be comprised of steel and, within the context of as good a protection against corrosion as possible, in particular of high grade steel. The internal cavity of the outer tube of the valve rod is advantageously completely filled, at least in the radial direction, i.e. in the direction orthogonally to the longitudinal extent of the valve rod, with the material having the modulus of elasticity of at least 250 gigapascal, preferably of at least 350 gigapascal, or with the continuous, elongate solid state body. This may, but does not absolutely have to be, the case over the entire longitudinal extent of the cavity.

As an alternative, it can also be provided, within the context of cladding the material mentioned, that at least regions of the outer surface of the continuous, elongate solid state body have a coating. The coatings can be comprised, for example, of nickel and/or chromium, but also of alloys comprising nickel and/or chromium, just to enumerate some of the various possibilities. They can be PVD (Physical Vapor Deposition) coatings or DLC (Diamond Like Carbon) coatings.

In order to facilitate the fastening of the closure member to the valve rod, preferred embodiments make provision for the first connection region for the closure member of the vacuum valve to comprise an outer casing made from high grade steel or another steel, or to be formed completely from high grade steel or another steel. On the other hand, however, within the context of appropriate rigidity of the valve rod, it is advantageously provided that the material having a modulus of elasticity of at least 250 gigapascal, preferably of at least 350 gigapascal, extends over at least 50%, preferably over at least 75%, of the length of the valve rod. The length of the valve rod here is, as stated, the greatest extent of the valve rod. The material having the modulus of elasticity mentioned advantageously extends as a single continuous, elongate solid state body over this length region of the valve rod.

In addition to the valve rod per se, the invention also relates to a vacuum valve comprising at least one valve opening which is surrounded by a valve seat, and a closure member, in particular a valve disk, for closing the valve opening, and comprising at least one valve rod, and comprising at least one valve drive, wherein the closure member is held on the valve rod, and the valve rod is held on the valve drive, which vacuum valve is characterized in that the valve rod is a valve rod according to the invention. Particularly preferably, valve rods according to the invention are used in those vacuum valves in which the valve rod is loaded particularly severely transversely with respect to its longitudinal extent. Within this context, preferred vacuum valves according to the invention make provision for a lifting direction for pressing the closure member against the valve seat to be arranged in an angled manner, preferably orthogonally, to a longitudinal axis along which the valve rod extends longitudinally. In the case of such vacuum valves, the lifting direction for pressing the closure member against the valve seat therefore runs neither coaxially nor parallel to the longitudinal axis of the valve rod.

The above-mentioned cladding, whether in the form of a coating or of the mentioned outer tube of the valve rod, advantageously extends at least over that region of the valve rod which is located or may be located in the vacuum region of the vacuum valve.

For the sake of completeness, it is also pointed out that vacuum technology is generally referred to if operating states having pressures of less than or equal to 0.001 mbar or 0.1 Pascal are reached. Vacuum valves are valves which are configured for these pressure ranges and corresponding differential pressures with respect to the surroundings. Nevertheless, it is pointed out that the modulus of elasticity of at least 250 gigapascal, preferably of at least 350 gigapascal, of the material used according to the invention is advantageously achieved at normal conditions, i.e. under normal atmospheric ambient pressure and at room temperature (for example 20° C.).

### BRIEF DESCRIPTION OF THE DRAWINGS

Further advantages and details of the invention are explained below with reference to the attached drawings, in which:

FIG. 1 shows a view of a vacuum valve with a valve rod according to a first embodiment of the invention, in the open position of the valve plate;

FIGS. 2 to 4 show sections along the lines AA, BB and CC of FIG. 1;

FIG. 5 shows a view corresponding to FIG. 1, but in the intermediate position of the valve plate;

FIGS. 6 to 8 show sections along the lines AA, BB and CC of FIG. 5;

FIG. 9 shows a view corresponding to FIG. 1, but in the closed position of the valve plate;

FIGS. 10 to 12 show sections along the lines AA, BB and CC of FIG. 9;

FIG. 13 shows a perspective view of the drive of the vacuum valve with the valve rod and the valve plate attached thereto, corresponding to the first embodiment of the invention;

FIG. 14 shows a perspective view corresponding to FIG. 13; parts of the valve are illustrated in excluded form;

FIG. 15 shows a top view of a further variant embodiment of a vacuum valve corresponding to the first embodiment of the invention;

FIG. 16 shows a section along the line AA from FIG. 15, and

FIGS. 17 and 18 show alternative embodiments of a valve rod according to the invention, which embodiments can likewise be used in the vacuum valves according to FIGS. 1 to 16.

### DETAILED DESCRIPTION OF THE PREFERRED EMBODIMENTS

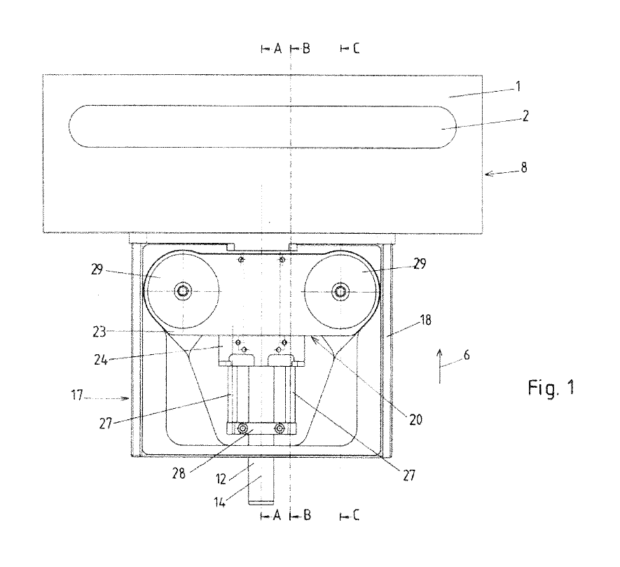

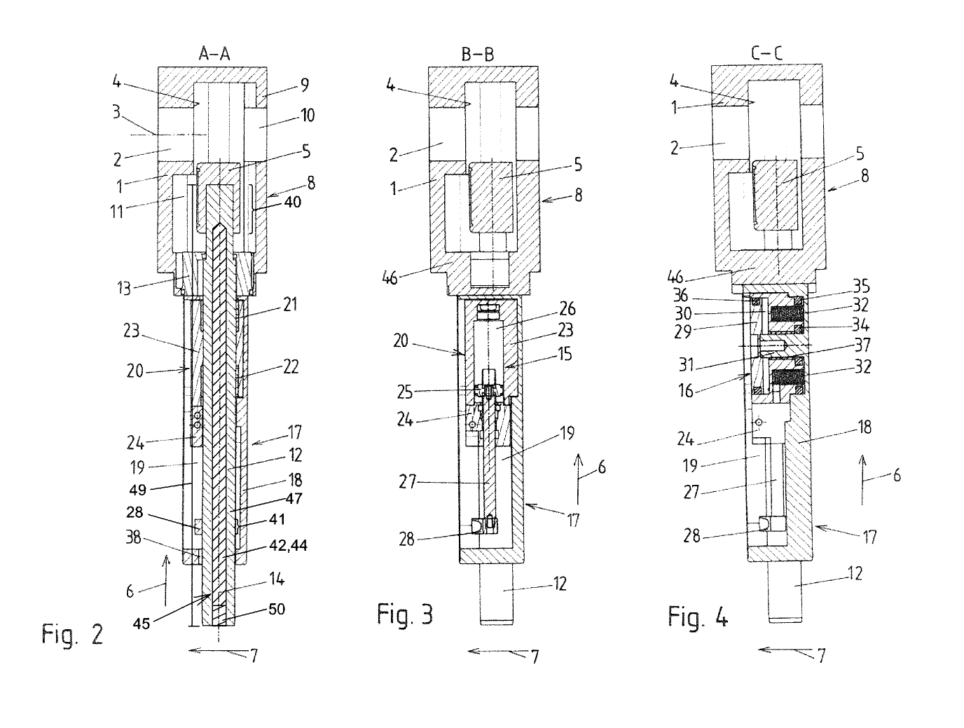

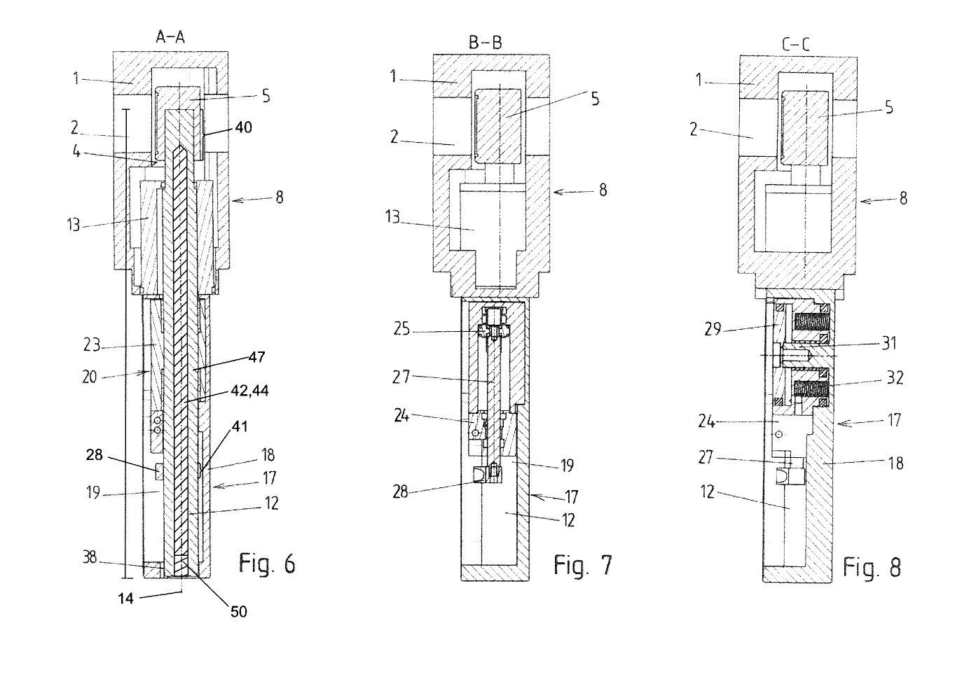

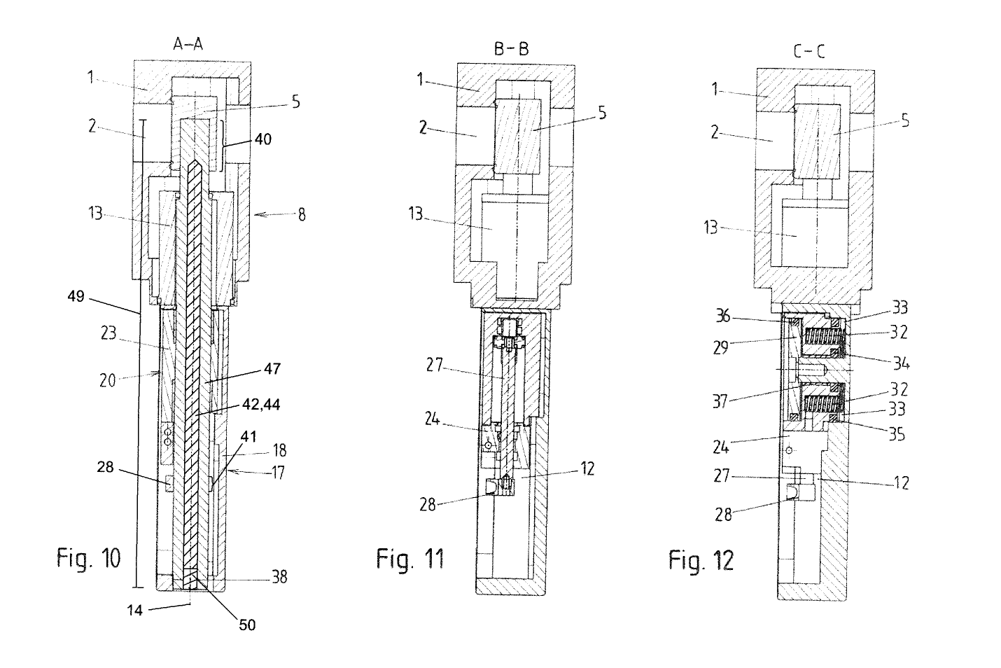

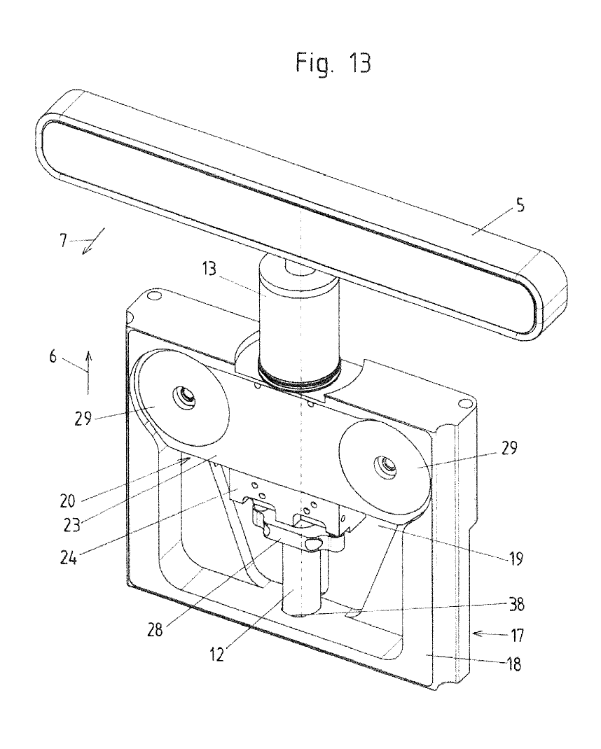

In the first embodiment of a valve rod 12 according to the invention, as shown in the vacuum valves according to FIGS. 1 to 16, the material 42 having the modulus of elasticity of at least 250 gigapascal, preferably of at least 350 gigapascal, is arranged in an elongate internal cavity 45 of an outer tube 47 of the valve rod 12. The material 42 therefore forms the core of the valve rod 12 and is itself shaped as a continuous, elongate solid state body in the form of the rod 44. The length of the rod 44, as measured along the longitudinal axis 14, is also more than 50%, here even more than 75%, of the length 49 of the valve rod 12 in this example. The rod 44 completely fills the internal cavity 45 of the outer tube 47. At the end facing away from the closure member 5, which is designed here as a valve plate, the internal cavity 45 of the outer tube 47 is closed by means of a closure 50. It may be a closure 50 which is screwed in or else is cast in or fastened in some other way. It can also be provided that the rod 44 comprised of the material 42 mentioned is so readily held by itself in the internal cavity 45 that the closure 50 can be dispensed with. The first connection region 40 serves for fastening the closure member 5 to the valve rod 12. As is also realized here, said first connection region 40 is advantageously manufactured completely or at least as an outer casing from high grade steel or another steel. Within the context of freedom from particles and freedom from corrosion in the vacuum region, the exemplary embodiment shown involves high grade steel, from which the rest of the outer tube 47 is also produced. The valve drive which here comprises the longitudinal driving device 15 and the transverse driving device 16 engages in the second connection region 41. The valve drive is fastened to the valve rod 12 via the yoke 28 here. By means of this fastening of the valve rod 12 to the valve drive, the valve rod 12 is moved together with the closure member 5 between the complete open position, which is shown in FIGS. 2 to 4, in the longitudinal direction 6 into the intermediate position according to FIGS. 6 to 8 and then in the lifting or transverse direction 7 into the closed position in order to press the closure member 5 against the valve seat 4. This takes place as known per se from DE 10 2008 049 353 A1. In this connection, reference is made to the following:

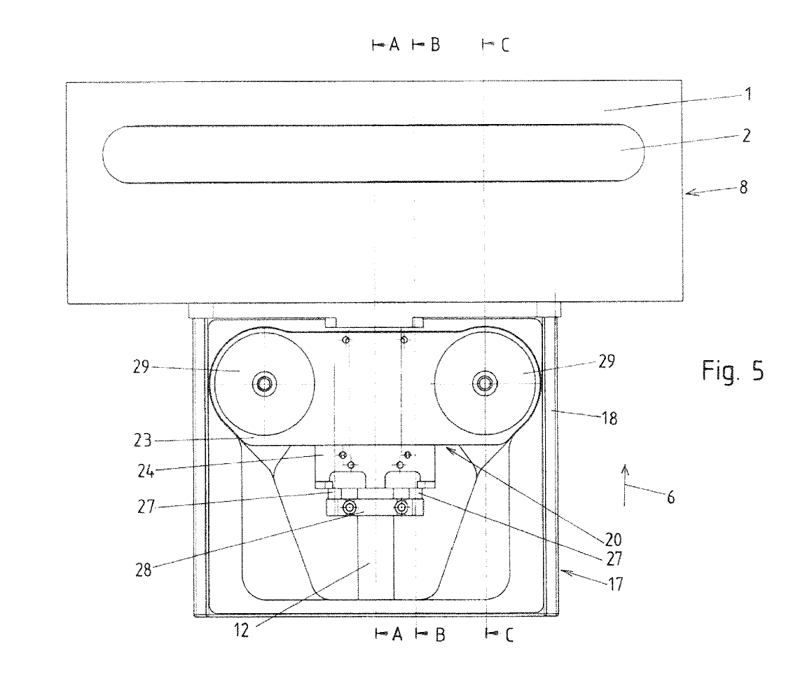

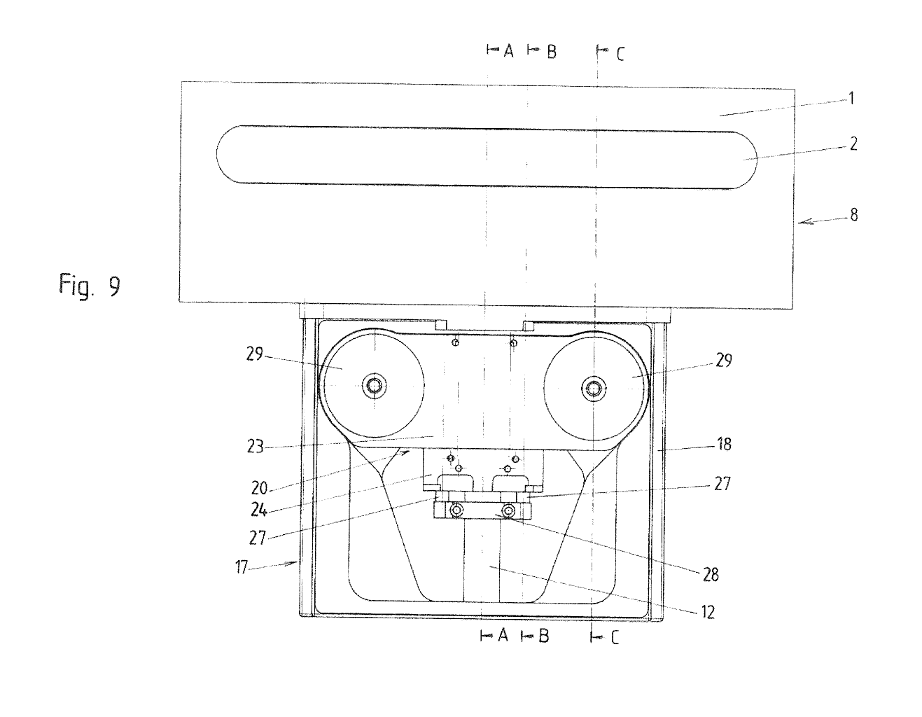

The vacuum valve of FIGS. 1 to 14 comprises a wall 1 with a valve opening 2 which has an axis 3 and is surrounded by a valve seat 4 which, in the exemplary embodiment, is formed by a sealing surface. For the vacuum-tight closing of the valve opening 2 in a closed state of the vacuum valve (cf. FIGS. 9 to 12), a valve plate 5 is provided as the closure member. In the open state of the vacuum valve (cf. FIGS. 1 to 4), the valve plate 5 advantageously completely opens up the valve opening 2, wherein said valve plate is preferably arranged entirely next to the valve opening 2 with respect to the direction of the axis 3 of the valve opening 2. Starting from this open position of the valve plate 5, in order to close the vacuum valve the valve plate 5 can first of all be displaced in the longitudinal direction 6 until it covers the valve opening 2 (as seen in the direction of the axis 3), but is still raised here from the valve seat 4. The intermediate position of the valve plate 5 is illustrated in FIGS. 5 to 8. The displacement of the valve plate 5 from its open position into its intermediate position takes place rectilinearly in the longitudinal direction 6 over the entire adjustment path. Furthermore, the valve plate 5 is displaced from its intermediate position in a transverse direction or lifting direction 7, which is at right angles to the longitudinal direction 6 and is parallel here to the axis 3, in the direction of the valve seat 4 and pressed against the valve seat 4 in order to seal the valve opening 2. In this closed position of the valve plate 5 (cf. FIGS. 9 to 12), the vacuum valve is closed. The displacement from the intermediate position into the closed position takes place rectilinearly in the transverse direction 7 over the entire adjustment path. In order to press the closure member 5 against the valve seat 4 in the lifting direction 7, the valve rod 12 is loaded relative to its longitudinal axis 14 in an angled, preferably orthogonal, direction. By the use of the material 42 which is mentioned at the beginning and has a correspondingly high modulus of elasticity, the valve rod 12, because of its design according to the invention, is particularly readily suitable for this use since it is flexurally rigid.

In the closed position, an elastic sealing ring which is arranged on the valve plate 5 is pressed against the sealing surface forming the valve seat 4. The opening of the vacuum valve takes place in the reverse sequence, i.e. from the closed position of the valve plate 5 into its intermediate position and further into its open position.

The valve plate 5 which is arranged in a vacuum region (=evacuable region) of the vacuum valve is attached to the valve rod 12 which is led out of the vacuum region of the valve by means of a bellows feedthrough, i.e. a section of the valve rod 12 is located in the vacuum region and another section of the valve rod 12 is located outside the vacuum region. The bellows feedthrough is formed by a bellows 13 (only illustrated schematically in the figures), for example an expansion bellows or a diaphragm bellows, which is connected vacuum-tightly on one side to the valve rod 12 and vacuum-tightly on the other side to a wall 46 which is connected rigidly to the wall 1 and is at an angle, preferably a right angle, to the wall 1, specifically in the region of an opening through the wall 46, through which the valve rod 12 projects. The valve plate 5, as illustrated, can be connected rigidly to the valve rod 12, or this connection may have elasticity in order to permit a certain adaptation of the valve plate 5 to the valve seat 4 in the closed position of the valve plate 5. Elastic connections of this type between the valve plate 5 and the valve rod 4 are known.

The longitudinal axis 14 of the valve rod 12 lies parallel to the longitudinal direction 6. In order to adjust the valve plate 5 between its open position and its intermediate position, the valve rod 12 is displaceable in the longitudinal direction 6 in relation to the wall 1. In order to adjust the valve plate 5 between its closed position and its intermediate position, the valve rod 12 is displaceable in parallel in the transverse direction 7 in relation to the wall 1. Instead of a bellows feedthrough for guiding the valve rod out of the vacuum region, a linear feedthrough could also be provided. This may comprise a sliding part which has a through opening through which the valve rod 12 is guided in a manner sealed by the use of a seal. The valve rod 12 is therefore displaceable in the longitudinal direction 6 in relation to said sliding part. The sliding part itself is mounted displaceably in the transverse direction 7 in relation to the wall 46, wherein said sliding part is sealed in relation to the wall 46 by means of a seal. The sliding part therefore forms a type of carriage which is sealed in relation to the wall 46 and is displaceable in the transverse direction 7. Linear feedthroughs of this type which permit displaceability in two directions, in particular lying orthogonally to each other, are known.

In order to open and close the vacuum valve, use is made of the valve drive which comprises a longitudinal driving device 15, which is arranged outside the vacuum region and by which the valve rod 12 is displaceable in the longitudinal direction 6, and a transverse driving device 16, which is likewise arranged outside the vacuum region and by which the valve rod 12 is displaceable in the transverse direction or lifting direction 7.

In the exemplary embodiment shown, the wall 1 forms a part of a valve housing 8 that also has a wall 9 which is opposite the wall 1 in the exemplary embodiment and has a further opening 10. The valve opening 2 and the opening 10 are part of a through channel, which is opened up in the opened state of the valve, through the valve housing 8, which through channel runs rectilinearly in the exemplary embodiment. The valve plate 5 is accommodated in the interior 11 of the valve housing 8, the interior constituting a vacuum region of the vacuum valve.

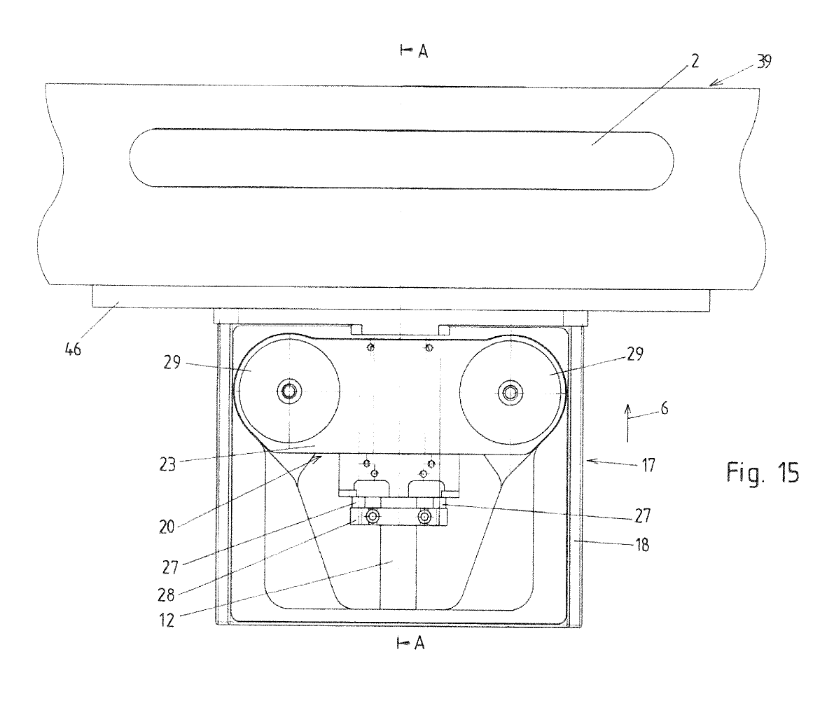

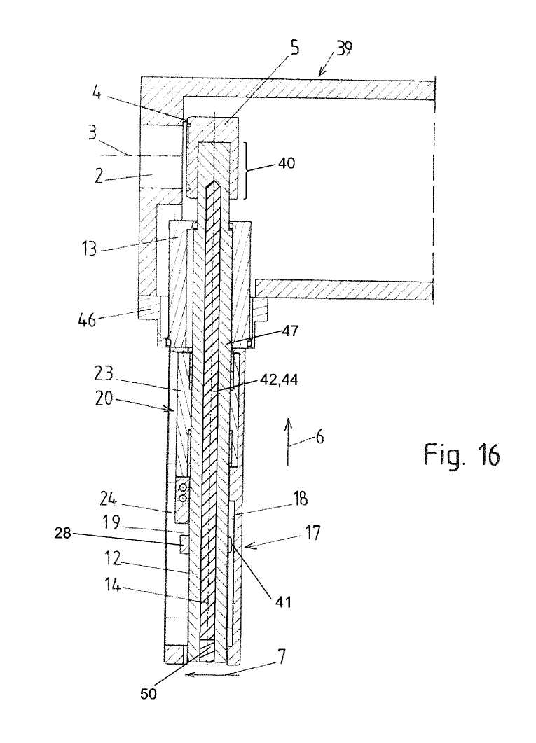

Instead, the wall 1 could also be part of a vacuum chamber (as explained further below with reference to FIGS. 15 and 16). Furthermore, the vacuum valve could form a type of insert in which the wall 1 is inserted into the vacuum region of a vacuum chamber.

The more precise description of the displaceable mounting of the valve rod 12 in the longitudinal and transverse direction 6, 7 and of the longitudinal and transverse driving devices 15, 16 now follows:

Outside the vacuum region of the vacuum valve, a supporting unit 17 is connected rigidly to the wall 1. In the exemplary embodiment shown, the supporting unit 17 comprises a drive housing 18 which is connected rigidly to the wall 1 or to the valve housing 8 having the wall 1 and which comprises a receiving space 19. A guide unit 20 is arranged in the receiving space 19, said guide unit being guided in the receiving space 19 in a manner displaceable rectilinearly in the transverse direction 7. By the guide unit 20 in turn, the valve rod 12 is guided displaceably in the longitudinal direction 6. In this connection, a base body 23 of the guide unit 20 has a passage channel through which the valve rod 12 penetrates and in which the valve rod 12 is guided by means of guide bushings 21, 22 so as to be displaceable in the longitudinal direction 6. The displaceable guidance of the guide unit 20 in relation to the supporting unit 17 is explained more precisely further below.

In the exemplary embodiment shown, the longitudinal driving device 15 comprises, as actuators, two pistons 25 which are each arranged in a cylinder recess 26 in the base body 23 of the guide unit 20. The cylinder recesses 26 are closed by a cylinder cover 24 of the guide unit 20, through which cylinder cover the piston rods 27 which are attached to the piston 25 penetrate. The piston rods 27 are fixedly connected via a yoke 28 to the valve rod 12, and therefore, when the pistons 25 are displaced in the cylinder recesses 26 by means of a pressure medium, preferably compressed air, the valve rod 12 is carried along in the longitudinal direction 6. For connection to the valve rod 12, the yoke 28 is, for example, screwed thereto or is connected thereto in a form-fitting and/or frictionally engaged and/or materially bonded manner.

The transverse driving device 16 comprises, as actuators, two pistons 29 with seals 36, which pistons are arranged in cylinder recesses 30 which are formed in the base body 23 of the guide unit 20. The pistons 29 are secured on piston rods 31 which, in the exemplary embodiment shown, are formed integrally with the drive housing 18 of the supporting unit 17. Within this context, the pistons 29 constitute parts of the supporting unit 17. The pistons rods 31 could also be formed by separate parts of the supporting unit 17, which parts are rigidly connected to the drive housing 18 of the supporting unit 17.

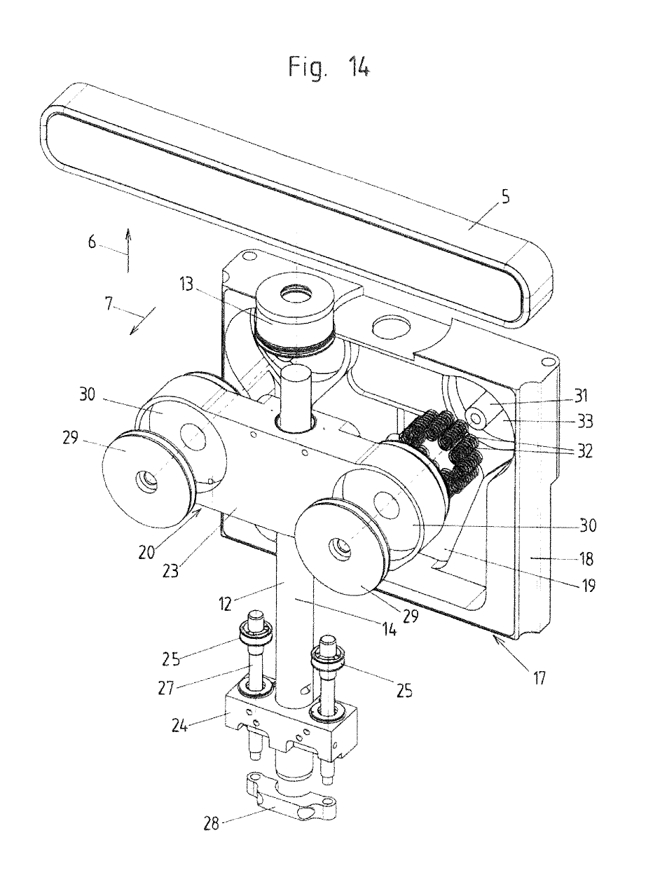

In the exemplary embodiment shown, the pistons 29 are designed as single-action pistons. By action upon the space lying between the piston 29 and the drive housing 18 on the side of the piston rod 31, the guide unit 20 and, with the latter, the valve rod 12 can be displaced in the transverse direction 7 in relation to the supporting unit 17 in such a manner that the valve plate 5 is displaced from its closed position into its intermediate position. In order to displace the guide unit 20 and, with the latter, the valve rod 12 and the valve plate 5 in the reverse direction, a spring device is used once initially in the exemplary embodiment shown. This spring device comprises a plurality of helical springs 32 acting between the guide unit 20 and the drive housing 18. The helical springs 32 are arranged on a circle surrounding a respective piston rod 31 (in FIG. 14, the helical springs are illustrated only at a piston rod 31, for the sake of clarity). Other arrangements of helical springs 32 and/or the use of other springs for forming a spring device of this type are also conceivable and possible.

If, in the closed position of the valve plate 5, no relatively great differential pressure acts on the valve plate 5, the differential pressure acting with the effect of pressing the valve plate 5 away from the valve seat 4, the contact pressure force, which is exerted on the valve plate 5 by the spring device, against the valve seat 4 is sufficient in order to seal the valve opening 2. This may be the case, for example, if the vacuum valve is provided for sealing between two vacuum chambers, and a vacuum process, for example for the semiconductor industry, is carried out in one of the chambers.

If, in the event of a greater differential pressure, which urges the valve plate 5 away from the valve seat 4, a higher contact pressure force of the valve plate 5 against the valve seat 4 is required, a pressure chamber 33 provided between the base body 23 of the guide unit and the drive housing 18 of the supporting unit 17, or, in the exemplary embodiment shown, two such pressure chambers 33, may also be acted upon with a pressure medium, in particular compressed air. The pressure chambers 33 are sealed by seals 34, 35.

Higher differential pressures which urge the valve plate 5 toward the valve seat 4 or away from the latter may occur, for example, in the event of the flooding of one of the two vacuum chambers connected by the vacuum valve, for example for maintenance purposes.

The helical springs 32 or differently designed springs could also be omitted. Instead of springs and/or pressure chambers 33, double-action pistons 29 could also be provided.

Guide bushings 37 which are arranged between the piston rods 31 and the base bodies 23 of the guide units 20 serve for guiding the guide unit 20 in relation to the supporting unit 17 (cf. FIGS. 4, 8 and 12). The seal 34 and/or the seal 35 and/or the seal 36 can also be designed in such a manner that it takes on a guiding function. In this case, the guide bushings 37 may also be omitted.

The valve rod 12, which protrudes out of the guide unit 20 on that side of the guide unit 20 which faces away from the valve plate 5, interacts in this section protruding out of the guide unit 20, in the closed position of the valve plate 5, with a transverse stop 38 arranged on the drive housing 18 of the supporting unit 17, preferably as illustrated in the end region of the valve rod 12. In the open position of the valve plate 5 and in the intermediate position of the valve plate 5, the valve rod 12 is spaced apart from the transverse stop 38. When the valve plate 5 moves from the intermediate position into the closed position, the valve rod 12 runs against the transverse stop 38, preferably at the same time as the valve plate 5 runs against the valve seat 4. The valve rod 12 is therefore supported against the wall 1 or against a part connected rigidly to the wall 1 on both sides of the engagement region of the transverse driving device 16 on the valve rod 12, wherein said engagement region lies in the region of the displaceable mounting of the valve rod 12 in relation to the guide unit 20. Due to this, the required contact pressure force of the valve plate 5 against the valve seat 4 can be transmitted in a simple manner without large tilting forces having to be absorbable by the longitudinal guidance of the valve rod 12 and the transverse guidance of the guide unit 20.

The longitudinal driving device 15 and/or transverse driving device 16 may also comprise more or fewer than the two pistons 25 and 29 shown. Instead of the formation of the cylinder recesses 26 and/or 30 for the pistons 25 of the longitudinal driving device 15 and/or for the pistons 29 of the transverse driving device 16 as recesses in the base body 23 of the guide unit 20, separate cylinders which are rigidly connected to the guide unit could also be provided. The reverse arrangement of the cylinders and of the pistons is also conceivable and possible. The pistons of the longitudinal driving device 15 could thus be connected rigidly to the guide unit 20 and the cylinders of said pistons to the valve rod 12 and/or the pistons 29 of the transverse driving device 16 could be connected rigidly to the guide unit 20 and the cylinders for said pistons could be connected rigidly to the supporting unit 17 or could be designed in the form of cylinder recesses in the supporting unit 17.

In the variant embodiment illustrated in FIGS. 15 and 16, the valve drive, the valve rod 12 and the valve plate 5 which is connected to the latter are formed identically as illustrated in FIGS. 1 to 14. The sole difference of this variant embodiment consists in that the wall 1 of the vacuum valve which has the valve opening 2 here is part of a vacuum chamber 39, which is merely partially and schematically illustrated in FIGS. 15 and 16. The valve plate 5 lies within the vacuum chamber 39 which constitutes a vacuum region of the valve when the vacuum chamber is evacuated. The wall 46, through the opening of which the valve rod 12 is led out of the vacuum region of the vacuum chamber 39, is illustrated in FIGS. 15 and 16 as a separate part which is connected to the vacuum chamber 39 via a flange connection, specifically in the region around an opening in the vacuum chamber 39. By opening of said flange connection, the wall 46 together with the valve drive attached thereto and together with the valve rod 12 and the valve disk 5 can therefore be removed.

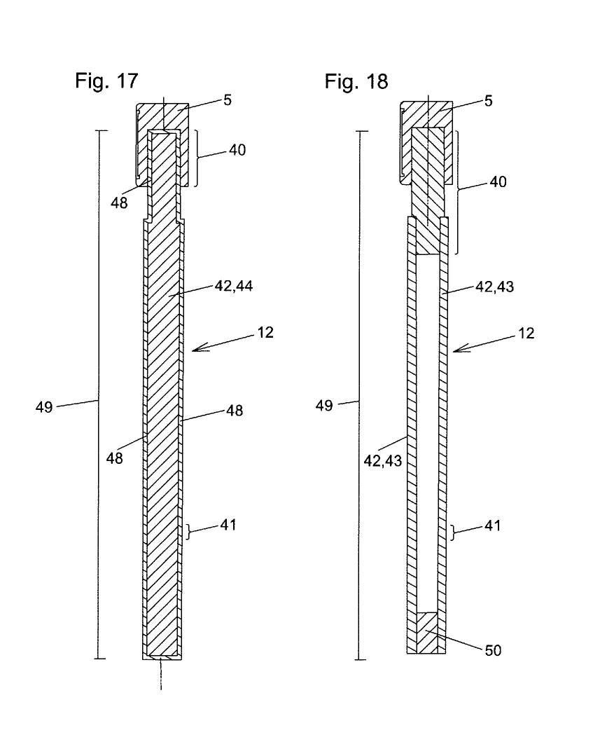

As explained at the beginning, a respective valve rod 12 with an outer tube 47, for example composed of high grade steel, and a rod 44, which is arranged in the internal cavity 45 of said outer tube and is composed of the material 42 having the high modulus of elasticity mentioned, is used in the two above-explained variants of a vacuum valve. Alternative valve rods 12 which can be used in these vacuum valves, but also in other vacuum valves and which are designed in accordance with the invention are shown by way of example in FIGS. 17 and 18. In FIG. 17, the valve rod 12 has an elongate, continuous solid state body which is likewise designed in the form of a rod 44 and is comprised of a material 42 having a modulus of elasticity of at least 250 gigapascal, preferably of at least 350 gigapascal. This material is provided on the outside with a coating 48. As explained at the beginning, this may be, for example, a nickel and/or chromium coating. Like the outer tube 47, the coating 48 particularly readily ensures that the valve rod 12 does not corrode and otherwise particles are also not liberated from the valve rod 12. For the sake of completeness, it is pointed out that, both in the case of the valve rod 12 according to the first FIGS. 1 to 16 and in the case of the valve rod 12 according to FIG. 17, a tube 43 comprised of the corresponding material 42 could be used instead of the rod 44. FIG. 18 now also shows a variant of a valve rod 12 according to the invention in which the material 42 having a modulus of elasticity of at least 250 gigapascal, preferably of at least 350 gigapascal, is designed as a tube 43. In this exemplary embodiment, the material 42 at least in regions directly forms the outer surface of the valve rod 12. Therefore, neither a coating 48 nor an outer tube 47 is present here. However, also in this exemplary embodiment, the first connection region 40 for fastening the closure member 5 to the valve rod 12 is formed from high grade steel. As stated, this simplifies the fastening of the closure member 5 to the valve rod 12, but is not an obligatory requirement. In a departure, in this exemplary embodiment, as in the other exemplary embodiments, the fastening of the closure member 5 to the valve rod 12 could also take place directly at the material 42. In the exemplary embodiment shown, the first connection region 40 is introduced in regions as a type of plug into the tube 43. The same applies to the closure 50 which is arranged on the other side and which is pushed completely here into the tube and could optionally also be dispensed with. Alternatively, however, both the closure 50 and the first connection region 40 could also have a type of sleeve into which the tube 43 or a corresponding rod 44 composed of the same material 42 could be plugged.

These are only some examples of valve rods 12 according to the invention. The mentioned features of valve rods 12 according to the invention and of the preferred embodiment thereof may also be combined with one another in a different manner. Above all, valve rods 12 according to the invention can also be used in different vacuum valves than the ones shown and described in FIGS. 1 to 16.

### KEY TO THE REFERENCE SIGNS

1 Wall

2 Valve opening

3 Axis

4 Valve seat

5 Closure member

6 Longitudinal direction

7 Lifting direction

8 Valve housing

9 Wall

10 Opening

11 Interior

12 Valve rod

13 Bellows

14 Longitudinal axis

15 Longitudinal driving device

16 Transverse driving device

17 Supporting unit

18 Drive housing

19 Receiving space

20 Guide unit

21 Guide bushing

22 Guide bushing

23 Base body

24 Cylinder cover

25 Piston

26 Cylinder recess

27 Piston rod

28 Yoke

29 Piston

30 Cylinder recess

31 Piston rod

32 Helical spring

33 Pressure chamber

34 Seal

35 Seal

36 Seal

37 Guide bushing

38 Transverse stop

39 Vacuum chamber

40 First connection region

41 Second connection region

42 Material

43 Tube

44 Rod

45 Internal cavity

46 Wall

47 Outer tube

48 Coating

49 Length

50 Closure

1. A valve rod for a vacuum valve, comprising a first connection region for a closure member of the vacuum valve, and at least one second connection region for a valve drive of the vacuum valve, wherein at least sections of the valve rod comprise a material having a modulus of elasticity of at least 250 gigapascal.

2. The valve rod as claimed in claim 1, wherein the material having the modulus of elasticity of at least 250 gigapascal is a ceramic or a hard metal.

3. The valve rod as claimed in claim 1, wherein the material having the modulus of elasticity of at least 250 gigapascal forms a continuous, elongate solid state body.

4. The valve rod as claimed in claim 3, wherein the continuous, elongate solid state body is arranged in an oblong internal cavity of an outer tube of the valve rod, and the outer tube of the valve rod is comprised of a different material than the continuous, elongate solid state body.

5. The valve rod as claimed in claim 4, wherein the outer tube is comprised of steel.

6. The valve rod as claimed in claim 3, wherein at least regions of an outer surface of the continuous, elongate solid state body have a coating.

7. The valve rod as claimed claim 1, wherein the first connection region for the closure member of the vacuum valve comprises an outer casing made from high grade steel or another steel, or is formed completely from high grade steel or another steel.

8. The valve rod as claimed claim 1, wherein the material having a modulus of elasticity of at least 250 gigapascal extends over at least 50% of a length of the valve rod.

9. A vacuum valve comprising at least one valve opening which is surrounded by a valve seat, a closure member, for closing the valve opening, at least one valve rod and at least one valve drive, wherein the closure member is held on the valve rod, and the valve rod is held on the valve drive, and at least sections of the valve rod comprise a material having a modulus of elasticity of at least 250 gigapascal.

10. The vacuum valve as claimed in claim 9, wherein a lifting direction for pressing the closure member against the valve seat is arranged angled to a longitudinal axis along which the valve rod extends longitudinally.

11. The valve rod as claimed in claim 1, wherein the material has a modulus of elasticity of at least 350 gigapascal

12. The valve rod as claimed in claim 3, wherein the continuous, elongate solid state body is a tube or a rod.

13. The valve rod as claimed in claim 6, wherein the coating comprises at least one of nickel or chromium.

14. The valve rod as claimed in claim 1, wherein the material having a modulus of elasticity of at least 250 gigapascal extends over at least 75% of a length of the valve rod.
